(19) United States
(12) Patent Application Publication
(10) Pub. No.: US 2010/0298148 A1
(43) Pub. Date: Nov. 25, 2010

(54) Superconducting magnet system with refrigerator for re-liquifying cryogenic fluid in a tubular conduit

(75) Inventors: Klaus Schlenga, Linkenheim (DE); Claus Hanebeck, Rheinstetten (DE)

Correspondence Address: KOHLER SCHMID MOEBUS, RUPPMANNSTRASSE 27, D-70565 STUTTGART, DE

(73) Assignee: Bruker BioSpin GmbH, Rheinstetten (DE)

(21) Appl. No.: 12/805,343

(22) Filed: Jul. 27, 2010

Related U.S. Application Data
(63) Continuation of application No. 11/510,806, filed on Aug. 28, 2006.

(30) Foreign Application Priority Data
Sep. 9, 2005 (DE) 10 2005 042 834.7

(51) Int. Cl. H01F 6/04; H01F 6/06

(52) U.S. Cl. 505/163; 335/216

(57) ABSTRACT

A superconducting magnet system with a superconducting magnet coil system, which is disposed in a cryogenic fluid tank (2) of a cryostat (1), and an exchangeable refrigerator (5; 31) which is operated in a vacuum container (8) and is provided to re-liquefy the cryogenic fluid flowing through a tubular conduit (4; 21) is characterized in that the tubular conduit (4; 21) is rigidly installed in the cryostat (1). The refrigerator reaches its optimum performance during operation in a vacuum, and can be easily exchanged in case of a defect.

This application is a continuation of Ser. No. 11/510,806 filed Aug. 28, 2006 and also claims Paris Convention priority of DE 10 2005 042 834.7 filed Sep. 9, 2005 the complete disclosures of which are hereby incorporated by reference.

### BACKGROUND OF THE INVENTION

The invention concerns a superconducting magnet system with a superconducting magnet coil system which is disposed in a cryogenic fluid tank of a cryostat, and an exchangeable refrigerator which is operated in a vacuum container to re-liquefy the cryogenic fluid that flows through a tubular conduit.

A magnet system of this type is disclosed in Cryogenics 38 (1998), pages 337 to 341.

Superconducting magnet coil systems are used to generate strong magnetic fields. However, the superconducting properties only establish themselves at low temperatures. For this reason, the magnet coil system must be cooled and is therefore disposed in the cryogenic fluid tank of a cryostat. The cryogenic fluid is mainly present in its liquid state, having a maximum temperature which corresponds to its boiling point. Due to unavoidable heat input into the cryostat, the cryogenic fluid must normally be regularly refilled. This process causes downtimes and incurs expense, since refilling disturbs the system. For this reason, refrigerators are implemented, which re-condense the gaseous cryogenic fluid.

In order to reduce the temperature of the cryogenic fluid, cryogenic fluid is constantly pumped out of the cryogenic fluid tank. The pumped cryogenic fluid is thereby heated outside of the cryogenic fluid tank. The heated gaseous cryogenic fluid is returned to the cryogenic fluid tank. It is thereby guided into a tubular conduit which is cooled by the refrigerator. The gas is guided along the refrigerator via the tubular conduit, thereby optimally utilizing the cooling performance at all temperature levels. In order to maintain optimum cooling performance of the refrigerator, the refrigerator is disposed in a vacuum container. At the end of the tubular conduit, the cryogenic fluid is sufficiently cold to be re-liquefied. The tubular conduit terminates in the cryogenic fluid tank, into which the liquefied cryogenic drips.

Exchange of the refrigerator must be possible in case of defect. The tubular conduit of the magnet system described in Cryogenics 38 (1998), 337 to 341, is rigidly connected to the refrigerator. The tubular conduit extends in the cryogenic fluid tank and also in the vacuum container of the refrigerator. Exchange of the refrigerator simultaneously involves removal of the tubular conduit from an opening between the cryogenic fluid tank and the vacuum container, producing a leakage in the cryogenic fluid tank. Even during normal operation of the magnet system, the opening represents a weak point, since only detachable sealing mechanisms can be used between the opening and the tubular conduit. For this reason, expensive coolant can easily escape from the conventional magnet system.

In contrast thereto, it is the object of the present invention to further develop a superconducting magnet system of the above-mentioned type in such a manner that the regenerator can be easily exchanged in case of defect, and the sealing integrity of the cryogenic fluid tank during normal operation is improved.

### SUMMARY OF THE INVENTION

This object is achieved in accordance with the invention with a superconducting magnet system comprising a cryostat defining a first vacuum region, a neck tube extending downwardly from an upper surface of the cryostat within the first vacuum region, a cryogenic fluid tank integral with a lower end of the neck tube and extending outwardly and downwardly therefrom within the first vacuum region of the cryostat, a superconducting magnet coil system disposed in the cryogenic fluid tank, a second vacuum container disposed within the neck tube and extending downwardly from the upper surface of the cryostat, the second vacuum container defining a second vacuum region which is vacuum sealed with respect to the neck tube and with respect to the first vacuum region, a tubular conduit through which cryogenic fluid flows, the tubular conduit permanently installed within said the second vacuum container, and a refrigerator disposed within the tubular conduit in exchangeable thermal connection thereto to liquefy the cryogenic fluid.

In accordance with the invention, the tubular conduit is rigidly installed in the second vacuum container. Moreover, the tubular conduit is not rigidly connected to the refrigerator as in prior art, but may remain in the cryostat in case the refrigerator fails. The opening for the tubular conduit between the vacuum tank of the refrigerator and the cryogenic fluid tank can be optimally sealed, since removal of the tubular conduit is obviated. The invention thereby permits, in particular, rigid weldings between the tubular conduit, the second vacuum tank and the cryostat. Moreover, the cryogenic fluid tank need not be opened to exchange the refrigerator. The tubular conduit can be easily kept sealed irrespective of the refrigerator. In order to prevent flow of uncooled cryogenic fluid, a shut-off valve may e.g. be used in a region of the tubular conduit which is at room temperature.

When used in the specification and claims of the instant invention, the phrases “rigidly installed, rigidly connected, and permanently installed” to describe installation of the tubular conduit within the second vacuum container, mean that the tubular conduit cannot be displaced in or removed from the second vacuum container without interrupting operation of the cryostat. The cryostat or second vacuum container would have to be disassembled or even damaged to remove the tubular conduit. Such connections include welding seams. When used in the specification and claims of the instant invention, the phrases “exchangeable, can be exchanged, exchange, not rigidly connected” to describe the connection between the refrigerator and the tubular conduit, mean that the refrigerator is neither welded nor soldered to the tubular conduit and that the refrigerator can be displaced in or removed from the cryostat without interrupting operation of the cryostat.

In one particularly preferred embodiment of the inventive superconducting magnet system, the refrigerator has a first metallic coupling device which provides heat transfer from the tubular conduit to the region of the refrigerator to be cooled. The first coupling device improves thermal conduction between the refrigerator (or its region to be cooled) and the tubular conduit. The first coupling device may either directly contact the tubular conduit or one or more further heat-conducting components which, in turn, are thermally coupled to the tubular conduit.

In one preferred further development of this embodiment, the first metallic coupling device comprises concentric, disc-like elements.

Thermal insulation between the disc-like elements is facilitated to prevent thermal short-circuit along the refrigerator.

In a further development thereof, one section of the disc-like elements has the shape of part of a slotted ring. This provides resilient contact which improves thermal conduction. The slotted shape also prevents occurrence of eddy currents due to induction.

In another particularly preferred embodiment of the superconducting magnet system, the tubular conduit has a second coupling device which permits heat transfer from the tubular conduit to the region of the refrigerator to be cooled. The second coupling device may either directly contact the refrigerator (or its region to be cooled) or one or more further heat-conducting components which, in turn, are thermally coupled to the refrigerator. In particular, a first coupling device and a second coupling device may be provided which contact each other.

In a preferred design of this embodiment, the second metallic coupling device has concentric annular elements. The annular elements can be easily thermally insulated to prevent thermal short-circuiting along the tubular conduit. With particular preference, the annular elements come in contact with disc-like elements of a first coupling device.

In a further advantageous development of the above-mentioned embodiments and further developments, the first and/or second metallic coupling device consists of copper or aluminum. These materials have good heat-conducting properties even at low temperatures.

In another preferred embodiment of the inventive superconducting magnet system, the tubular conduit is substantially helical. The helical shape provides a relatively large contact region, and the refrigerator need not be angularly aligned relative to the tubular conduit.

In an alternative embodiment, the tubular conduit has several parallel, interconnected annular sections. This embodiment facilitates prevention of thermal short-circuits along the tubular conduit or the refrigerator, thereby still providing large contact regions. The annular sections may cooperate particularly well with annular elements and/or disc-like elements of a second or first coupling device.

In another preferred embodiment, the tubular conduit has an inner diameter of between 2 mm and 8 mm. Such diameters have proven to be useful in practice, in particular, in view of flow and the danger of ice formation.

In another preferred embodiment, the tubular conduit is produced from stainless steel. Stainless steel combines good mechanical stability and reduced heat conduction.

In one preferred embodiment of the inventive superconducting magnet system, the refrigerator is substantially rotationally symmetric in its region facing the tubular conduit. This facilitates assembly and disassembly of the refrigerator. Alignment about the longitudinal axis of the refrigerator, which regularly coincides with the input and output direction in the cryostat, is not required.

In one further preferred embodiment, a guidance is provided for installation and removal of the refrigerator. The guidance facilitates installation and removal and ensures an optimum contact position for thermal coupling between the tubular conduit and the refrigerator in the installed state.

In an advantageous further development of this embodiment, at least one rail is provided as guiding means. A rail is easy to handle and inexpensive to produce.

In another further development, the refrigerator is, alternatively or additionally, substantially conical in its region facing the tubular conduit or the first metallic coupling device is substantially conical, and the tubular conduit is substantially funnel-shaped in its region facing the refrigerator or the second metallic coupling device is substantially funnel-shaped. Funnel and cone cooperate well by defining a stop, providing a large contact surface for thermal coupling as well as mutual guidance.

In a further preferred embodiment of the inventive superconducting magnet system, the vacuum container is formed from magnetic material. This shields the interior of the vacuum container, in particular, the refrigerator and large parts of the tubular conduit from magnetic fields.

In another advantageous embodiment, the cryogenic fluid is helium. Helium can yield particularly low temperatures.

In an alternative embodiment, the cryogenic fluid is hydrogen, neon or nitrogen.

In one further advantageous embodiment, the refrigerator is a pulse tube cooler. Pulse tube coolers have proven to be useful in practice.

In an alternative embodiment, the refrigerator is a Gifford-McMahon cooler.

In a further advantageous embodiment, the magnet system is a magnetic resonance apparatus.

Further advantages of the invention can be extracted from the description and the drawings. The features mentioned above and below may be used individually or collectively in arbitrary combination. The embodiments shown and described are not to be understood as exhaustive enumeration but have exemplary character for describing the invention.

The invention is explained in more detail in the drawing.

### BRIEF DESCRIPTION OF THE DRAWING

FIG. 1 shows a schematic partial view of a cryostat for an inventive superconducting magnet system, wherein the tubular conduit has several parallel annular sections;

FIG. 2 shows a schematic partial view of a cryostat for an inventive superconducting magnet system, wherein the tubular conduit is helical;

FIG. 3 shows a schematic view of a refrigerator for an inventive superconducting magnet system, wherein the refrigerator comprises a first metallic coupling device which has several concentric disc-like elements; and

FIG. 4 shows a cross-section through a disc-like element of FIG. 3, wherein the right-hand section of the disc-like element has the shape of part of a slotted ring.

### DESCRIPTION OF THE PREFERRED EMBODIMENT

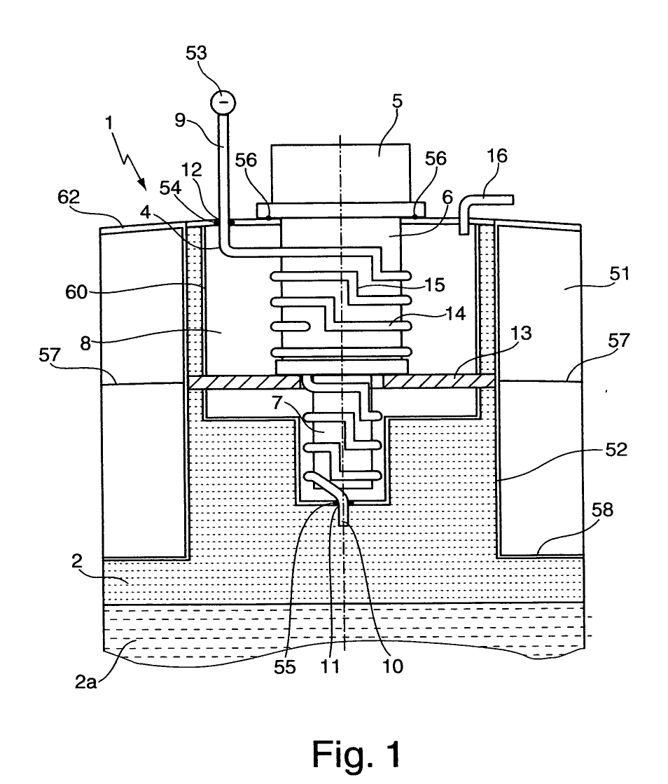

FIG. 1 schematically shows part of an inventive superconducting magnet system, i.e. the neck tube 52 region of a cryostat 1. The cryostat 1 defines a first vacuum region 51. The neck tube 52 extends downwardly within the first vacuum region 51 from an upper surface 62 of the cryostat 1 and is integral with a cryogenic fluid tank 58 whose lower region contains cryogenic liquid 2a, i.e. liquid helium. A superconducting magnet coil configuration (not shown) is located in the region of the liquid cryogenic fluid 2a. Gaseous cryogenic fluid (indicated by dots in FIG. 1) is located above the liquid cryogenic fluid 2a. Cryogenic fluid is permanently pumped to reduce the temperature. The pumped cryogenic fluid is thereby heated outside of the cryogenic fluid tank 2.

The heated, gaseous cryogenic fluid is cooled and returned, in its liquefied state, to the cryogenic fluid tank 2 via a tubular conduit 4. A refrigerator 5 cools the cryogenic fluid. The refrigerator 5 has a first cooling stage 6 and a second, colder cooling stage 7. These two cooling stages 6, 7 are contained in a second vacuum region 8 defined by a second vacuum container 60 to thermally insulate them from the surroundings. The second vacuum container 60 extends downwardly within the neck tube 52 from the upper surface 62 of the cryostat. The tubular conduit 4 is also located in the second vacuum container 60, except for the inlet 9 and outlet 10. The vacuum container 60 is evacuated at a pressure of at most 10⁻³ mbar or less during normal operation. The vacuum in the second vacuum container 60 is established via a pumping connection 16.

The cryogenic fluid to be liquefied is supplied to the tubular conduit 4 via the inlet 9. The tubular conduit 4 abuts the outer walls of the cooling stages 6, 7, i.e. the region of the refrigerator 5 to be cooled, thereby cooling the tubular conduit 4.

The cryogenic fluid thereby flows to the coldest part of the refrigerator 5, i.e. the lower end of the second cooling stage 7. Just before the outlet 10, the cryogenic fluid in the tubular conduit 4 is sufficiently cold to be liquefied. It finally drips from the outlet 10 back into the cryogenic fluid tank 58.

The tubular conduit 4 is permanently installed in the cryostat 1. It cannot be displaced in or removed from the cryostat 1 without interrupting operation of the cryostat 1. The cryostat would have to be disassembled or even damaged to remove the tubular conduit. The tubular conduit 4 is mounted in the cryostat 1 using any conventional means, in particular, through screwing and welding.

The tubular conduit 4 of FIG. 1 is rigidly connected to the cryostat 1 in three regions. The tubular conduit 4 is welded 55, along its entire periphery, to the lower wall of the second vacuum container 60 at a passage opening 11 of the tubular conduit 4 between the second vacuum container 60 and the cryogenic fluid tank 58, i.e. in the region of the outlet 10. This yields maximum sealing between the second vacuum container 60 and the cryogenic fluid tank 58. Another welding 54 is provided at the opening 12 between the tubular conduit 4 at the upper surface 62 of the cryostat 1 and the second vacuum region 8, i.e. in the region of the inlet 9 (use of an elastic seal would also be possible herein). The tubular conduit 4 is finally also rigidly connected to a support level 13 which, in turn, is rigidly connected to the wall of second vacuum container 60 and the wall of the neck tube 52 of the cryostat 1. The support level 13 also thermally couples a radiation shield 57 disposed in the first vacuum region 51 of the cryostat 1.

In contrast thereto, the refrigerator 5 can be exchanged. The lower edge of the first cooling stage 6 is supported on the support level 13. The refrigerator 5 can be removed in an upward direction out of the second vacuum region 8 defined by second vacuum container 60 and separated from thermal contact with tubular conduit 4. This breaks the vacuum in the second vacuum container 60, without causing leakage to the cryogenic fluid tank 58 and without affecting the first vacuum region 51 within the cryostat 1. Either a repaired or a new refrigerator 5 can subsequently be inserted into the second vacuum container 60. Accordingly, the cryogenic fluid tank 58 remains closed during complete exchange of the refrigerator 5. Since the cryogenic fluid that flows through the tubular conduit 4 during exchange of the refrigerator 5 can temporarily not be cooled, the cryogenic fluid circuit should be interrupted to exchange the refrigerator. Towards this end, a shut-off valve 53 can be used in the feed line 9 of the tubular conduit 4. The refrigerator 5 seats on the upper surface 62 of the cryostat and seals 56 the second vacuum region 8 from the ambient environment external to the cryostat 1.

The tubular conduit 4 of the embodiment of FIG. 1 has several parallel annular sections 14. The annular sections 14 extend in a horizontal plane, i.e. perpendicular to the axis of the refrigerator 5. The annular sections 14 are connected to vertical connecting sections 15. Each annular section 14 may have its own temperature level.

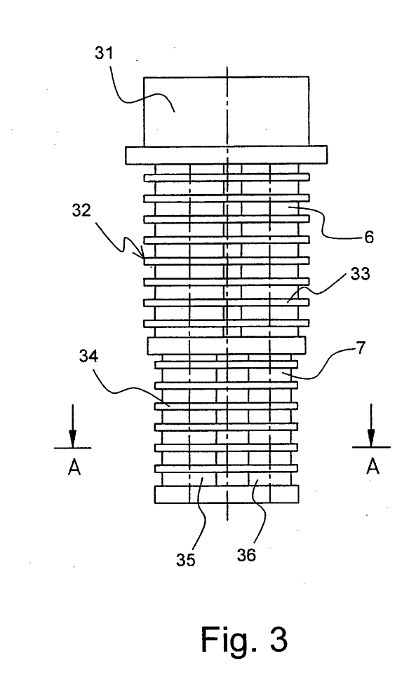

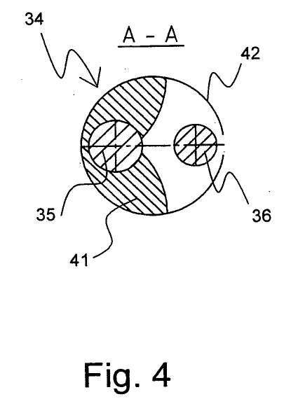

The annular sections 14 may cooperate well with disc-like elements of a first metallic coupling device of the refrigerator 5 (not shown in FIG. 1, see FIGS. 3 and 4) in that the annular sections 14 and the disc-like elements are at the same level in the mounted state of the refrigerator 5, with their surfaces contacting each other.

In accordance with the invention, the tubular conduit 4 may be provided with a second metallic coupling device to improve thermal coupling between the tubular conduit 4 and the refrigerator 5. Towards this end, each annular section 14 may, in particular, be surrounded by annular elements (not shown). The annular elements may, in turn, cooperate with disc-like elements of a first coupling device on the refrigerator 5.

The first and second coupling devices are divided into disc-like and annular elements, which prevents formation of thermal short-circuits which would disadvantageously increase the minimum achievable temperature on the refrigerator 5.

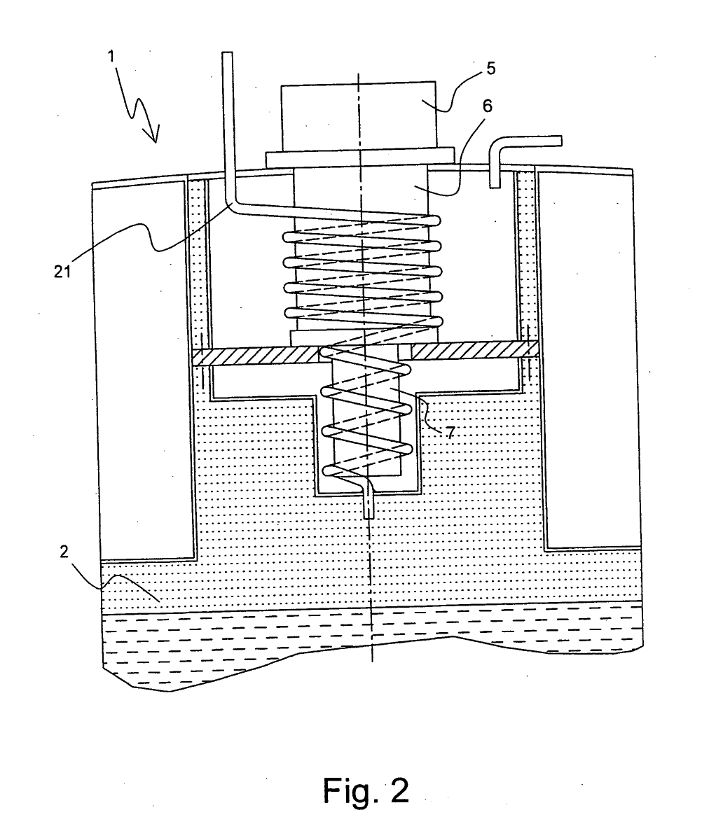

FIG. 2 also shows the neck tube region of a cryostat 1 of an inventive superconducting magnet system. The tubular conduit 21 therein is helical, i.e. is wound in a downward direction (in the direction of coolant flow) on the cooling stages 6, 7 of the refrigerator 5, and finally terminates in the cryogenic fluid tank 2.

FIG. 3 shows a refrigerator in accordance with the invention, which can be used in an inventive superconducting magnet system. The refrigerator 31 is provided with a first cooling stage 6 and a second cooling stage 7. The refrigerator 31 has a first metallic coupling device 32 which comprises several disc-like elements 33, 34. These disc-like elements 33, 34 surround the refrigerator 31 at certain locations in a plane perpendicular to its direction of extension or axis. Moreover, the disc-like elements 33, 34 each project past the respective diameter of the refrigerator 5, such that the edges of the disc-like elements 33, 34 can be easily contacted without touching the cooling stages 6, 7 of the refrigerator 5. The sides of the disc-like elements 33, 34 are made from copper to increase thermal conduction. In order to prevent thermal conduction along the direction of extension of the refrigerator 31, the disc-like elements 33, 34 are separated from each other and are not connected, except for the respective cooling stage 6, 7. Each disc-like element can therefore form its own temperature level that can be tapped.

Two regenerator tubes 35 and two pulse tubes 36 extend within the two-stage refrigerator 31. The lowest temperatures are reached at the lower end of each tube.

FIG. 4 shows a cross-section through a disc-like element 34 corresponding to the cut A in FIG. 3. The regenerator tube 35 and the pulse tube 36 extend through the disc-like element 34. An approximately moon-shaped section 41 of the disc-like copper element 34 surrounds the regenerator tube 35. The outer edge of the moon-shaped section 41 provides good thermal coupling to the cold regenerator tube 35. In this figure, the right-hand half of the disc-shaped element has a section 42 in the form of a slotted ring. Two metal tongues extending on a circular arc, whose ends are disposed at a mutual separation from each other, substantially form the section 42. The pulse tube 36 extends inside the region past which the metal tongues project, and is not in direct contact with the disc-shaped element 34, thereby thermally insulating the relatively warm pulse tube 36.

The metal tongues may be elastically deformed. This permits application to a tubular conduit or a second metallic coupling device with spring force support, which improves thermal conduction.

In summary, the invention describes a superconducting magnet system with a superconducting magnet coil system which is disposed in a cryogenic fluid tank 2 of a cryostat 1, and an exchangeable refrigerator 5; 31 which is operated in a vacuum container 8 to re-liquefy the cryogenic fluid flowing through a tubular conduit 4; 21, characterized in that the tubular conduit 4; 21 is rigidly installed in the cryostat 1. The refrigerator reaches its optimum performance during operation in vacuum, and can be easily exchanged in case of a defect.

We claim:

1. A superconducting magnet system comprising:
a cryostat, said cryostat defining a first vacuum region;
a neck tube, said neck tube extending downwardly from an upper surface of said cryostat within said first vacuum region;
a cryogenic fluid tank integral with a lower end of said neck tube and extending outwardly and downwardly therefrom within said first vacuum region of said cryostat;
a superconducting magnet coil system disposed in said cryogenic fluid tank;
a second vacuum container disposed within said neck tube and extending downwardly from said upper surface of said cryostat, said second vacuum container defining a second vacuum region which is vacuum sealed with respect to said neck tube and with respect to said first vacuum region;
a tubular conduit through which cryogenic fluid flows, said tubular conduit permanently installed within said second vacuum container; and
a refrigerator disposed within said tubular conduit in exchangeable thermal connection thereto to liquefy said cryogenic fluid.

2. The superconducting magnet system of claim 1, wherein said refrigerator has a first metallic coupling device, which permits heat transfer from said tubular conduit to a cooling region of said refrigerator.

3. The superconducting magnet system of claim 2, wherein said first metallic coupling device has concentric disc-like elements.

4. The superconducting magnet system of claim 3, wherein a section of said disc shaped elements has a shape of part of a slotted ring.

5. The superconducting magnet system of claim 2, wherein said tubular conduit has a second coupling device which permits heat transfer from said tubular conduit to a cooling region of said refrigerator.

6. The superconducting magnet system of claim 5, wherein said second metallic coupling device has concentric annular elements.

7. The superconducting magnet system of claim 5, wherein said first and/or said second metallic coupling device is made from copper or aluminum.

8. The superconducting magnet system of claim 1, wherein said tubular conduit is substantially helical.

9. The superconducting magnet system of claim 1, wherein said tubular conduit has several parallel, interconnected annular sections.

10. The superconducting magnet system of claim 1, wherein said tubular conduit has an inner diameter of between 2 mm and 8 mm.

11. The superconducting magnet system of claim 1, wherein said tubular conduit is made from stainless steel.

12. The superconducting magnet system of claim 1, wherein said refrigerator is substantially rotationally symmetrical in a region facing said tubular conduit.

13. The superconducting magnet system of claim 1, further comprising a guidance for installation and removal of said refrigerator.

14. The superconducting magnet system of claim 13, wherein a region of said refrigerator facing said tubular conduit is substantially conical and a region of said tubular conduit facing said refrigerator is substantially funnel-shaped.

15. The superconducting magnet system of claim 5, wherein a region of said refrigerator facing said tubular conduit is substantially conical and a region of said tubular conduit facing said refrigerator is substantially funnel-shaped.

16. The superconducting magnet system of claim 15, wherein said region of said refrigerator is substantially conical and said region of said tubular conduit is substantially funnel-shaped.

17. The superconducting magnet system of claim 1, wherein said vacuum container is made from magnetic material.

18. The superconducting magnet system of claim 1, wherein the cryogenic fluid is helium.

19. The superconducting magnet system of claim 1, wherein the cryogenic fluid is hydrogen, neon, or nitrogen.

20. The superconducting magnet system of claim 1, wherein said refrigerator comprises a pulse tube cooler.

21. The superconducting magnet system of claim 1, wherein the refrigerator comprises a Gifford-McMahon cooler.

22. The superconducting magnet system of claim 1, wherein magnet system is structured for a magnetic resonance apparatus.
